(19) United States
(12) Patent Application Publication
(10) Pub. No.: US 2011/0227300 A1
(43) Pub. Date: Sep. 22, 2011

(54) ADAPTER FOR MULTIFUNCTIONAL TOOL

(75) Inventors: Xiaofeng Zhang, Nanjing (CN); Zhiguo Chen, Nanjing (CN); Baijun Zhang, Nanjing (CN)

(73) Assignee: CHERVON LIMITED, Wanchai (HK)

(21) Appl. No.: 12/831,844

(22) Filed: Jul. 7, 2010

(30) Foreign Application Priority Data
Mar. 19, 2010 (CN) 201020141442.5

(51) Int. Cl. B25F 3/00

(52) U.S. Cl. 279/143

(57) ABSTRACT

An adapter for a multifunctional tool includes a converter with a first form-locating component mating with an output shaft end of the multifunctional tool and a fixer with a form-fit component mateable with the converter.

### RELATED APPLICATION INFORMATION

This application claims the benefit of CN 201020141442.5 filed on Mar. 19, 2010 the disclosure of which is incorporated herein by reference in its entirety.

### BACKGROUND

This disclosure generally relates to multifunctional tools and, more particularly, to an adapter for multifunctional tool.

Some multifunctional tools with multiple replaceable tool heads are currently available. The replaceable tool heads are selected to be mounted to the multifunctional tool for implementing various cutting functions so that the multifunctional tool can be used in various working situations. The multifunctional tool generally comprises a motor driving assembly arranged to drive a shifting fork to swing through a spherical bearing mounted on an eccentric output shaft, thereby driving the tool head to swing. Each of various tool heads adapts to a special function, for example, some tool heads are saw blades and some are sandpaper or polishers.

However, tool heads for multifunctional tools of different brands or from different manufacturers often are formed with different connecting shapes or structures so that a user must prepare and equip special tool heads for each multifunctional tool of a certain brand or from a certain manufacture that is owned by the user.

To solve the above problem, some multifunctional tools are equipped with an adapter which is adapted to an output shaft on one end and to the tool heads on the other end so as to mount tool heads of different connecting shapes or structures to the same multifunctional tool. While such adapters provide easy operation, they have somewhat limited universality and thus cannot meet the demands of users to adapt more tool heads of different connecting shapes and structures to different multifunctional tools.

### SUMMARY

The subject disclosure is directed to an improved adapter for a multifunctional tool. Generally, the adapter includes a converter arranged with a first form-locating component which is mateable with a shaft end of an output shaft of the multifunctional tool and a fixer arranged with a form-fit component which is mateable with the converter.

### BRIEF DESCRIPTION OF THE DRAWINGS

FIG. 1 is a front view illustrating a converter of an adapter for a multifunctional tool constructed according to the description that follows;

FIG. 2 is a sectional view along line A-A of FIG. 1;

FIG. 3 is a front view illustrating a fixer of the adapter for the multifunctional tool;

FIG. 4 is a top view illustrating the fixer of the adapter for the multifunctional tool;

FIG. 5 is a schematic view illustrating the adapting between the adaptor and a tool head and a shaft end;

FIG. 6 is another schematic view illustrating the adapting between the adaptor and a tool head and a shaft end;

FIG. 7 is a perspective view illustrating a converter of a further adapter for a multifunctional tool constructed according to the description that follows;

FIG. 8 is a schematic view illustrating the adapting between the further adapter and a tool head and a shaft end; and

FIG. 9 is another schematic view illustrating the adapting between the further adapter and a tool head and a shaft end.

### DETAILED DESCRIPTION

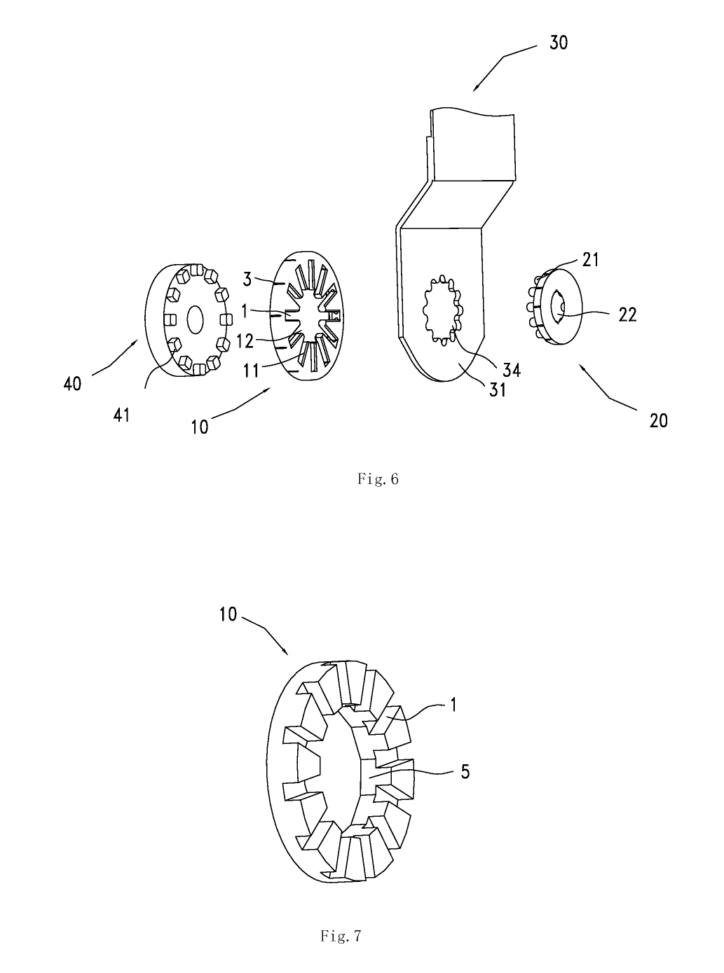

Referring to FIGS. 1 and 2, a converter 10 of an adapter for a multifunctional tool is shown. The converter 10 is embodied with a disc-shape as a whole on which a first form locating component 1 and a first center-aligning component 2 are arranged. A central hole 4 is formed on the converter 10 for being passed through by fasteners such as bolts when the converter 10 is assembled. The first form locating component 1 comprises a plurality of radial grooves formed around the central hole 4 and which extend through both end side surfaces of the disc-shaped converter 10. The first center-aligning component 2 is embodied as an annular convex shoulder of step shape arranged on one end side surface of the converter 10. A plurality of scale grooves 3 are set on an outer peripheral surface of the converter 10 for a user to observe to determine a rotating angle of location. The central hole 4 of the radial first form-locating component 1 of the converter 10 can be used to align a center position of the converter 10 to an output shaft of the multifunctional tool. Referring to FIG. 6, for achieving a more reliable aligning of the center position of the converter 10, center lines of the converter 10 and the output shaft of the multifunctional tool are aligned to be superposed by the annular convex shoulder of step shape enclosing onto an outer cylinder surface of the output shaft end 40 of the multifunctional tool.

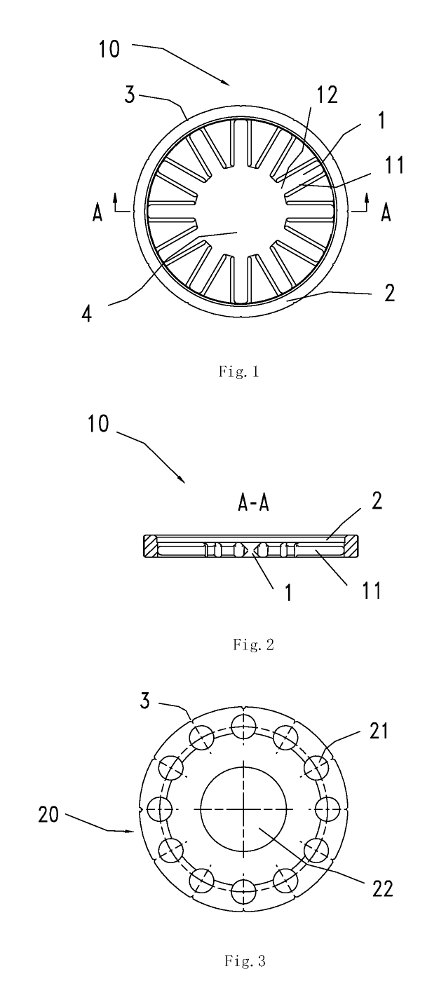

Referring to FIGS. 3 and 4, a fixer 20 of the adapter is shown. The fixer 20 is embodied with a disc-shaped as a whole on which a form-fit component 21 and a second center-aligning component 22 are arranged. The form-fit component 21 is embodied as a plurality of axial cylinder-shaped protrusions on an end side surface of the fixer 20 which faces a tool head when the tool head is mounted on the output shaft of the multifunctional tool along the circumferential direction of the fixer. The second center-aligning component 22 is embodied as a central hole formed on the fixer which is used to accept fastening means such as a bolt when the fixer 20 is placed into mating engagement. A plurality of scale grooves 3 are set on the fixer 20 for the user to observe to determine the rotating angle of location.

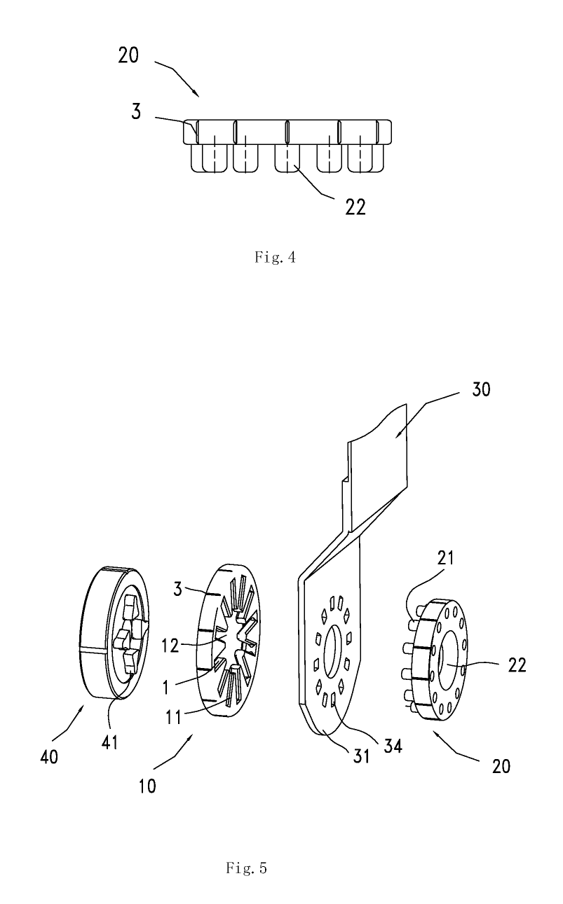

Referring to FIGS. 5 and 6, the shaft end 40 of the output shaft of the multifunctional tool is mounted with the adapter to adapt a tool head 30. By utilizing the adapter, different tool heads could be mounted onto different multifunctional tools. The protrusions on the fixer 20 pass through an axial hole 34 or holes 32 of a connecting segment 31 of a tool head 30 and extend into the grooves of the first form-locating component 1 of the converter 10. Thus, a tool head 30 and the converter 10 are prevented from moving in the circumferential direction relative to each other. By mating the fixer 20 with the converter 10, it is realized that a tool head 30 is located between the fixer 20 and the converter 10. Meanwhile, the grooves of the first form-locating component 1 of the converter 10 are mated with the axial protrusions 41 on the shaft end 40 so that the converter 10 and the shaft end 40 are relatively fixed in the circumferential direction. As for existing multifunctional tools, the structure of the axial protrusions 41 on a shaft end of the output shaft is usually embodied as protrusions distributed along a larger circle proximate to the periphery or as or more central protrusions. When the axial protrusions 41 are distributed along the larger circle proximate to the whole periphery, the protrusions 41 are axially inserted into the grooves of the first form-locating component 1 to achieve adapting between the shaft end 40 and the converter 10 through the slaving surfaces 11 on both sides of the grooves (referring to FIGS. 1 and 2). When the structure of the axial protrusion 41 is one or more central axial protrusions, the central axial protrusions will extend into the groove 12 along radial directions to achieve adapting between the shaft end 40 and the converter 10.

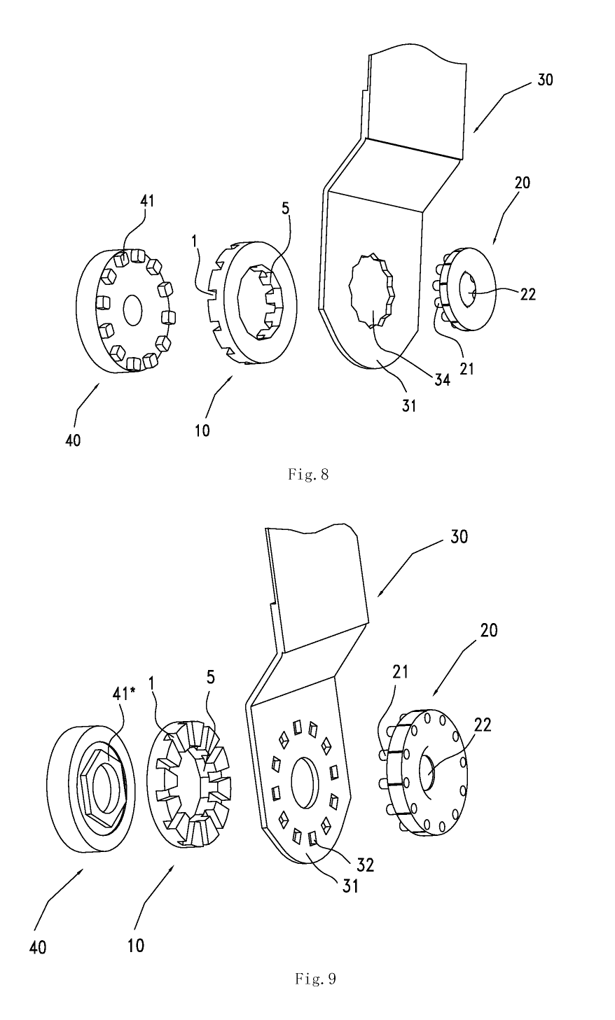

Referring to FIG. 7, a converter 10 of a further adapter for a multifunctional tool is shown. The converter 10 of the second embodiment is disc-shaped as a whole with a first form-locating component 1 and a second form-locating component 5 arranged thereon. The second form-locating component 5 is a polygonal shaped hole located at center of the converter 10, and the first form-locating component 1 is embodied as a plurality of the grooves radially extending on the outer surface of the polygonal shaped hole along the circumferential direction. The radially extending grooves are arranged on one end side of the disc-shaped converter 10.

The fixer 20 of the adapter for the multifunctional tool is the same as that of the first embodiment.

As shown in FIG. 8, the shaft end 40 of the output shaft of the multifunctional tool is mounted with a tool head 30 with the aid of the adapter of the second embodiment. A form-fit component 21 on the fixer 20 passes through the hole 34 of the connecting segment 31 of the tool head 30 and is mated with the second form-locating component 5 on the converter 10. Because the second form-locating component 5 is a polygonal shaped hole, the fixer cannot be rotated along the circumferential direction relative to the converter 10 to achieve the circumferential locating. The axial protrusions 41 arranged on the shaft end 40 are embedded into the first form-locating component 1 of the converter 10.

Referring to FIG. 9, the first form-locating component 1 and the second form-locating component of the adapter could be exchanged with each other. For example, the first form locating component 1 arranged as radial grooves could also be adapted with the form-fit component 21 of the fixer extending through the attachment, while the second form-locating component 5 of the polygonal shaped hole could be mated with the central protrusions 41′ arranged on the shaft end 40, which further enhances the universality of the attachment.

The above mentioned embodiments are only explanatory to the concept and principle of this invention and, as such, are not intended to limit the protection range of the invention. Those skilled in the art will contemplate that the invention will have a lot of other modifications or variations without departing from the spirit and concept of the invention. The protection range of this invention will thus be determined by the claims.

What is claimed is:

1. An adapter for a multifunctional tool, comprising:
a converter arranged with a first form-locating component mateable with an shaft end of an output shaft of the multifunctional tool; and
a fixer arranged with a form-fit component mateable with the converter.

2. The adapter of claim 1, wherein the first form-locating component comprises radial grooves formed along a circumferential direction of the converter.

3. The adapter of claim 2, wherein the converter is further formed with a second form-locating component in the form of a polygonal shaped hole for mating with the form fitting component.

4. The adapter of claim 1, wherein the form-fit component comprises protrusions arranged along a circumferential direction of the fixer.

5. The adapter of claim 4, wherein the protrusions are evenly distributed along the circumferential direction.

6. The adapter of claim 1, wherein the converter is further arranged with a first center-aligning component thereon.

7. The adapter of claim 6, wherein the first center-aligning component has an annular convex shoulder of step shape.

8. The adapter of claim 1, wherein the fixer is further arranged with a second center-aligning component thereon.

9. The adapter of claim 8, wherein the second center-aligning component is a centrally located hole.

10. The adapter of claim 1, wherein the converter and the fixer are both providing with scale grooves for use in rotational locating.
